(19) United States
(12) Patent Application Publication
(10) Pub. No.: US 2006/0068759 A1
(43) Pub. Date: Mar. 30, 2006

(54) Authentication system and authentication method

(76) Inventors: Hayato Ikebe, Higashiosaka-City (JP); Yoshinori Hatayama, Komaki-city (JP); Kazuya Ogawa, Mizuho-city (JP); Hiroshi Takemura, Aisai-city (JP)

Correspondence Address: MCDERMOTT WILL & EMERY LLP, 600 13TH STREET, N.W., WASHINGTON, DC, 20005-3096, US

(21) Appl. No.: 11/239,468

(22) Filed: Sep. 30, 2005

(30) Foreign Application Priority Data
Sep. 30, 2004 (JP) P2004-286003

(51) Int. Cl. H04M 1/66

(52) U.S. Cl. 455/411

(57) ABSTRACT

A home server according to the present invention includes: a storage unit for storing an operation item indicating a type of operation content of the remote operation, and operation data in which each operation item corresponds with necessity of an authentication; a transmission-reception unit for receiving the operation direction from the remote control terminal; an authentication necessity decider for deciding both the operation item and the necessity of the authentication based on the operation direction received and the operation data; and an authorization verifier for authenticating the operation direction as transmitted by the remote control terminal which has been authorized when the authentication necessity decider determines that the authentication is necessary.

### CROSS REFERENCE TO RELATED APPLICATIONS

This application is based upon and claims the benefit of priority from the prior Japanese Patent Applications No. P2004-286003, filed on Sep. 30, 2004; the entire contents of which are incorporated herein by reference.

### BACKGROUND OF THE INVENTION

1. Field of the Invention

The present invention relates to an authentication system and an authentication method for authenticating an operation direction for directing remote operation of a remote controlled device connected to a communications network as transmitted by an authorized remote control terminal.

2. Description of the Related Art

A home network has been put into practical use in recent years. The home network is a communications network for connecting devices installed inside of a house (for example, an electronic lock, an air conditioner and a lighting unit).

Since the device can be remotely controlled from a remote control terminal through the home network, convenience of the device connected to the home network (hereinafter referred to as a “remote controlled device” as appropriate) is significantly increased.

On the other hand, it is necessary that the remote controlled device is securely prevented from being controlled by an “unauthorized” remote control terminal, which is not authorized to remotely control the remote controlled devices. However, an operation direction which is important for insuring security, e.g., the locking and unlocking of an electronic lock installed to the entrance door, and an operation direction which is not so important, e.g., the turning on and off of a lighting unit are mixed up in the operation directions.

If authorization of all the operation directions are authenticated, in other words, if authorization whether or not the operation direction is transmitted by an authorized remote control terminal is authenticated, there is a problem being that the time required to perform remote operation tends to be increased.

In view of this, an authentication method of determining the necessity of authentication of the operation direction by referring to a database (table) has been disclosed (refer to Japanese Patent Laid-open No. 2003-143133, P. 7-8 and FIG. 8).

### BRIEF SUMMARY OF THE INVENTION

However, the conventional authentication method has the following problem. Specifically, the necessity of the authentication has to be set for each operation direction.

Further, remote controlled devices connected to the home network are added and changed frequently. According to the conventional authentication method, every time remote controlled devices are added or changed, a user has to set the necessity of the authentication of the operation direction and such setting is very troublesome work.

The present invention has been made in light of the aforementioned circumstances. An object of the present invention is to provide an authentication system and an authentication method, which is capable of setting the necessity of authentication of the operation direction more easily while reducing the time required for authenticating the operation direction directing remote operation.

To solve the aforementioned problem, the present invention has the following aspects. A first aspect of the present invention is an authentication system for authenticating an operation direction directing remote operation of a remote controlled device connected to a communications network as transmitted by a remote control terminal which has been authorized, including: an operation data storage unit configured to store operation data including an operation item indicating a type of an operation content for the remote operation and necessity of an authentication; an operation direction receiver configured to receive the operation direction from the remote control terminal; an authentication necessity decider configured to determine the necessity of the authentication based on the operation direction received by the operation direction receiver and the operation data; and an authenticator configured to authenticate the operation direction as transmitted by the remote control terminal which has been authorized when the authentication necessity decider determines that the authentication is necessary.

According to this authentication system, not all of the operation directions, but only operation directions whose authentication is defined as necessary by the operation data are authenticated. This can reduce the time required for authenticating the operation direction.

Further, according to this authentication system, in the operation data, each operation item indicating the type of operation content corresponds with the necessity of the authentication. It is therefore not required to set the necessity of authentication for each operation content, and thus allows easier setting of the necessity of authentication for the operation directions.

A second aspect of the present invention relates to the first aspect of the present invention, in which the authentication system further includes a signature adder configured to add an electronic signature to the operation direction of the remote operation whose authentication is necessary based on the operation content and the operation data stored in the operation data storage unit, and the authenticator verifies the electronic signature and thereby authenticates the operation direction received by the operation direction receiver as transmitted by the remote control terminal which has been authorized.

A third aspect of the present invention is an authentication method using an authentication system for authenticating an operation direction directing remote operation of a remote controlled device connected to a communications network as transmitted by a remote control terminal which has been authorized, the authentication system including an operation data storage unit for storing operation data including an operation item indicating a type of an operation content of the remote operation and necessity of an authentication, the authentication method including the steps of: receiving the operation direction from the remote control terminal; and authenticating the operation direction as transmitted by the remote control terminal which has been authorized when it is determined that the authentication is necessary based on the operation direction received and the operation data.

As described above, according to the aspects of the present invention, it is possible to provide an authentication system and an authentication method, which is capable of setting the necessity of authentication of the operation direction more easily while reducing the time required for authenticating the operation direction directing remote operation.

### BRIEF DESCRIPTION OF THE DRAWINGS

FIG. 1 is a schematic configuration diagram of a home network including an authentication system according to an embodiment of the present invention.

FIG. 2 is a logical block diagram of the authentication system and remote controlled devices according to the embodiment of the present invention.

FIG. 3 is a diagram showing an authentication method of remote operation using the authentication system according to the embodiment of the present invention.

FIG. 4 is a diagram showing the authentication method of remote operation using the authentication system according to the embodiment of the present invention.

FIG. 5 is a diagram showing an example of operation direction according to the embodiment of the present invention.

FIG. 6 is a diagram showing an example of operation data according to the embodiment of the present invention.

FIG. 7 is a diagram showing an example of a DCD used in the authentication system and the remote controlled devices according to the embodiment of the present invention.

### DESCRIPTION OF THE PREFERRED EMBODIMENTS

An embodiment of the authentication system according to the present invention will be described with reference to the drawings. It should be noted that the drawings are schematic, and that accordingly a ratio of one measurement to another and the like in the drawings is different from the actual authentication system. For this reason, specific measurements and the like should be decided taking into account the following descriptions. It should also be noted that the drawings include different portions from other drawings in terms of the measurements and their ratios.

(Schematic Configuration of a Home Network Including the Authentication System)

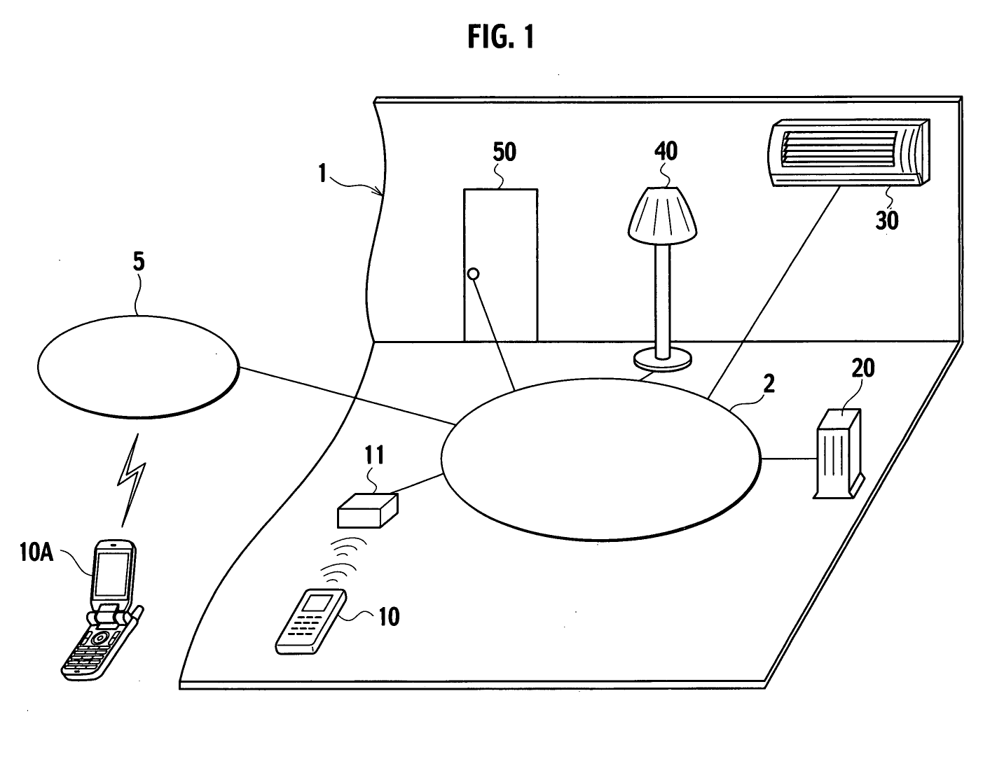

FIG. 1 shows a schematic configuration of a home network including the authentication system according to this embodiment. As shown in FIG. 1, a house 1 includes an entrance door 50 and an electronic lock is installed at the entrance door 50. Further, an air conditioner 30 and a lighting unit 40 are installed in the house 1.

The air conditioner 30, the lighting unit 40 and the entrance door 50 are connected to a home network 2 installed in the house 1. The air conditioner 30, the lighting unit 40 and the entrance door 50 constitute the remote controlled device in this embodiment. The house 1 according to this embodiment is not necessarily limited to a residential building, but includes a business-related building, for example.

The home network 2 is a communications network configured by a wired LAN conforming to IEEE802.3 series or the like, or a wireless LAN conforming to IEEE802.11 series or the like. Incidentally, the home network 2 may be a communications network conforming to another communication scheme (for example, IEEE1394).

Further, a home server 20 is connected to the home network 2. The home server 20 can control the air conditioner 30, the lighting unit 40 and the entrance door 50 through the home network 2.

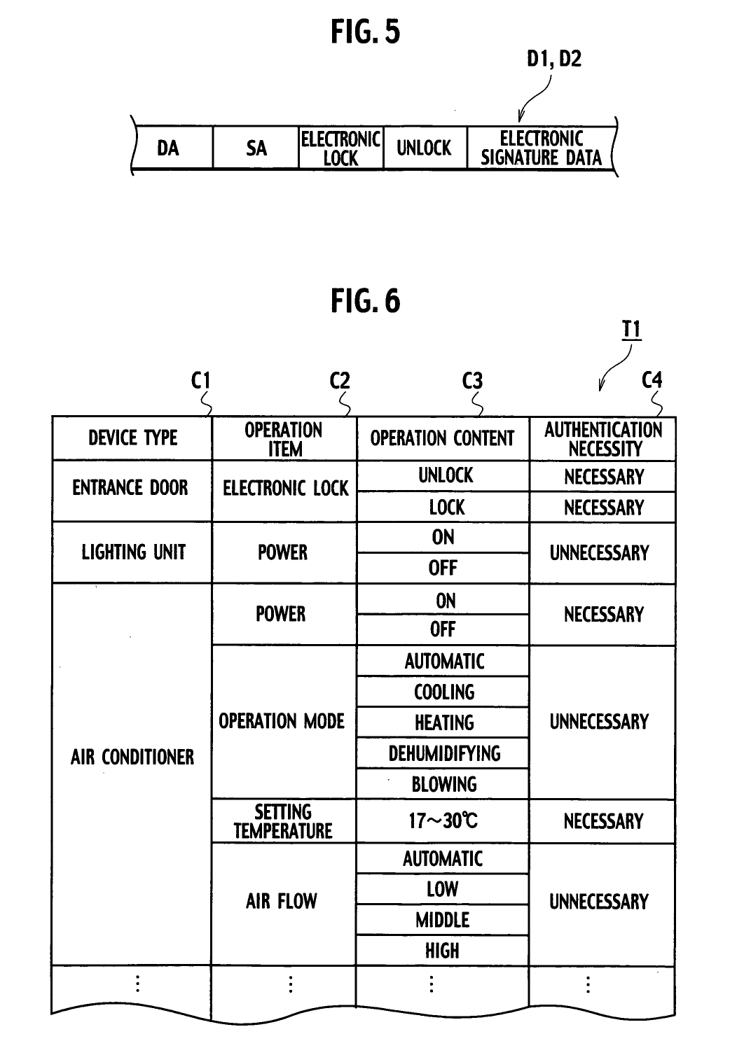

Specifically, a remote control terminal 10 transmits an operation direction D1 (see FIG. 5) for directing remote operation of a remote controlled device such as the air conditioner 30 and the like, to the home server 20 through a transceiver 11 connected to the home network 2.

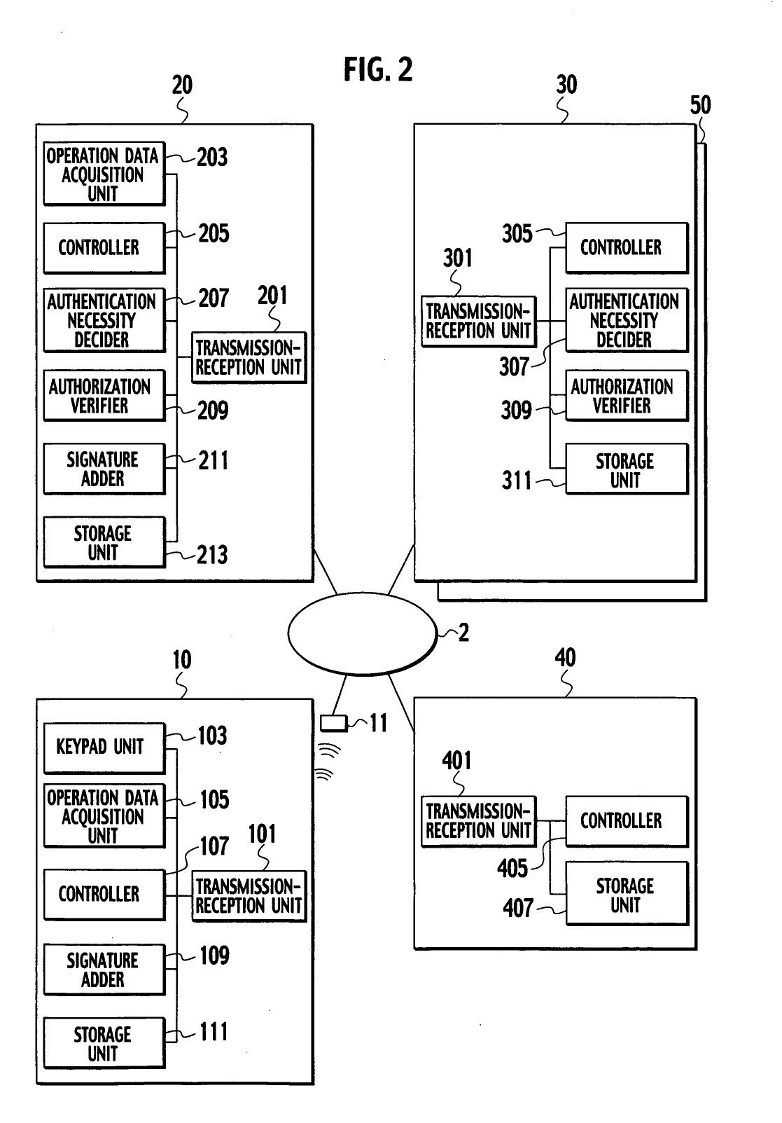

The home server 20 determines the necessity of the authentication of the operation direction based on the operation direction D1 transmitted by the remote control terminal 10 and an operation data table T1 (see FIG. 6) stored in a storage unit 213 (see FIG. 2) of the home server 20. When the operation direction D1 is authenticated, the home server 20 transmits an operation direction D2 (see FIG. 5) for directing remote operation of the remote controlled device through the home network 2 based on the operation direction D1.

In this embodiment, the authentication system is configured by the remote control terminal 10 and the home server 20. Incidentally, a method with which the home server 20 authenticates the operation direction D1 and a method with which the home server 20 controls the remote controlled device will be described later.

The home network 2 is connected to a wide area network 5. The wide area network 5 according to this embodiment includes the Public Switched Telephone Network (PSTN), the mobile telephone network and the Internet.

A cellular phone terminal 10A can access the wide area network 5 and can transmit the operation direction D1 to the home server 20 through the wide area network 5 and the home network 2. It means that the cellular phone terminal 10A can remotely control the air conditioner 30, the lighting unit 40 and the entrance door 50 similar to the remote control terminal 10.

(Configuration of Logical Blocks)

FIG. 2 shows a configuration of logical blocks of the remote control terminal 10, the home server 20, the air conditioner 30, the lighting unit 40 and the entrance door 50.

Hereinafter, descriptions will be provided mainly for parts concerned with the present invention. Accordingly, each of the devices shown in FIG. 2 may include a logical block which is essential for realizing the function of the device, but which is not illustrated or whose descriptions are omitted (a power supplier and the like).

(1) Remote Control Terminal

As described above, the remote control terminal 10 is used for remotely controlling the air conditioner 30, the lighting unit 40 and the entrance door 50 (remote controlled device) installed in the house 1.

The remote control terminal 10 includes a transmission-reception unit 101, a keypad unit 103, an operation data acquisition unit 105, a controller 107, a signature adder 109 and a storage unit 111.

The transmission-reception unit 101 transmits/receives various data through the transceiver 11. Specifically, the transmission-reception unit 101 transmits the operation direction D1 generated by the controller 107 to the home server 20, and receives contents of the operation data table T1 from the home server 20. Incidentally, a sub-microwave (for example, the 2.4 GHz band), a microwave or an infrared ray can be used for communications between the transmission-reception unit 101 and the transceiver 11.

The keypad unit 103 is configured by a keypad and the like to be operated by a user, and outputs to the controller 107 a signal corresponding to contents of key operations.

The operation data acquisition unit 105 acquires contents of the operation data table T1 from the home server 20. Specifically, once the home server 20 is informed by the controller 107 that the remote control terminal 10 can access the home network 2, the home server 20 transmits the contents of the operation data table T1 (operation data) stored in the storage unit 213 to the remote control terminal 10.

The operation data acquisition unit 105 acquires the contents of the operation data table T1 transmitted from the home server 20, and stores the acquired operation data table T1 to the storage unit 111.

The controller 107 controls each of the logical blocks constituting the remote control terminal 10. Further, the controller 107 generates the operation direction D1 based on the signal output by the keypad unit 103.

Here, FIG. 5 shows an example of the operation direction D1. As shown in FIG. 5, the operation direction D1 includes an operation item (electronic lock) and an operation content (unlock). Further, in this embodiment, an electronic signature data is added to the operation direction D1, which is a hash value calculated using the operation direction D1 and a predetermined one-way hash function.

Incidentally, a DA that is an identifier assigned to the home server 20 and an SA that is an identifier assigned to the remote control terminal 10 (for example, an IP address and a MAC address) are added to the operation direction D1.

The signature adder 109 adds an electronic signature to the operation direction D1 including the remote operation if it is determined that authentication is necessary based on the operation content which is input by a user using the keypad unit 103 and the operation data table T1 stored in the storage unit 111.

Specifically, as described above, the hash value is calculated using the operation direction D1 and the predetermined one-way hash function. The calculated hash value is added to the operation direction D1 as the electronic signature data.

The storage unit 111 stores the operation data table T1 acquired by the operation data acquisition unit 105. Incidentally, specific contents of the operation data table T1 will be described later.

It should be noted that the cellular phone terminal 10A shown in FIG. 1 has the same functions as the remote control terminal 10 with regard to the remote operation of the air conditioner 30, the lighting unit 40 and the entrance door 50.

(2) Home Server

The home server 20 includes a transmission-reception unit 201, an operation data acquisition unit 203, a controller 205, an authentication necessity decider 207, an authorization verifier 209, a signature adder 211 and a storage unit 213.

The transmission-reception unit 201 is connected to the home network 2. The transmission-reception unit 201 transmits/receives various data. Specifically, the transmission-reception unit 201 receives the operation direction D1 from the remote control terminal 10. In this embodiment, the transmission-reception unit 201 constitutes an operation direction receiver.

The transmission-reception unit 201 transmits the contents of the operation data table T1 to the remote control terminal 10 and the like. Further, the transmission-reception unit 201 transmits the operation direction D2 to the remote controlled device such as the air conditioner 30 and the like.

The operation data acquisition unit 203 acquires operation data for a remote controlled device from a device-information management server (not illustrated) and the like connected to the wide area network 5. Further, the operation data acquisition unit 203 can also acquire operation data stored in a data storage medium such as a CD-ROM.

The controller 205 controls each of the logical blocks constituting the home server 20. Further, the controller 205 generates the operation direction D2 for directing remote operation of a remote controlled device based on the operation direction D1 transmitted by the remote control terminal 10.

The generated operation direction D2 is transmitted to a remote controlled device (for example, the air conditioner 30) through the home network 2. The operation direction D2 has the same structure as the operation direction D1 has, as shown in FIG. 5.

The authentication necessity decider 207 determines the necessity of authentication of the operation direction D1 based on the operation direction D1 received by the transmission-reception unit 201 and the operation data table T1 stored in the storage unit 213. Incidentally, a method of determining the necessity of the authentication will be described later.

When the authentication necessity decider 207 determines that the authentication of the operation direction D1 is necessary, the authorization verifier 209 verifies that the operation direction D1 is transmitted by the remote control terminal, which has been authorized. In this embodiment, the authorization verifier 209 constitutes an authenticator.

Specifically, the authorization verifier 209 verifies the electronic signature included in the operation direction D1, and thereby authenticates the operation direction D1 received by the transmission-reception unit 201 as transmitted by a remote control terminal, which has been authorized.

The signature adder 211 adds the electronic signature to the operation direction D2 if it is defined that authentication of the operation content is necessary.

The storage unit 213 stores the operation data table T1 (operation data) including an operation item indicating the type of the operation content of the remote operations and necessity of an authentication. In this embodiment, the storage unit 213 constitutes an operation data storage unit.

Here, FIG. 6 shows contents of the operation data table T1 as an example of the operation data according to this embodiment. As shown in FIG. 6, the operation data table T1 is configured by a device type C1 indicating the remote controlled device, an operation item C2 indicating the type of remote operations, an operation content C3 indicating content of the remote operation, and an authentication necessity C4 indicating the necessity of the authentication.

As shown in FIG. 6, for example, in the case of the lighting unit 40, “power” is specified as the operation item C2. “on” and “off” are specified as the operation content C3 of the “power”. Further, the remote operation of the “power” is defined as unnecessary according to the authentication necessity C4.

In the case of the air conditioner 30, “power”, “operation mode”, “setting temperature”, “air flow” and the like are specified as the operation item C2. Further, each of the operation item C2 corresponds with each authentication necessity C4. For example, the “operation mode” is defined that authentication is unnecessary, and the “set temperature” is defined that authentication is necessary.

Similarly, in the case of the entrance door 50, “electronic lock” is specified as the operation item C2 and “unlock” and “lock” are specified as the operation content C3 of the electronic lock. Further, the “unlock” and “lock” are defined that authentication is unnecessary according to the authentication necessity C4.

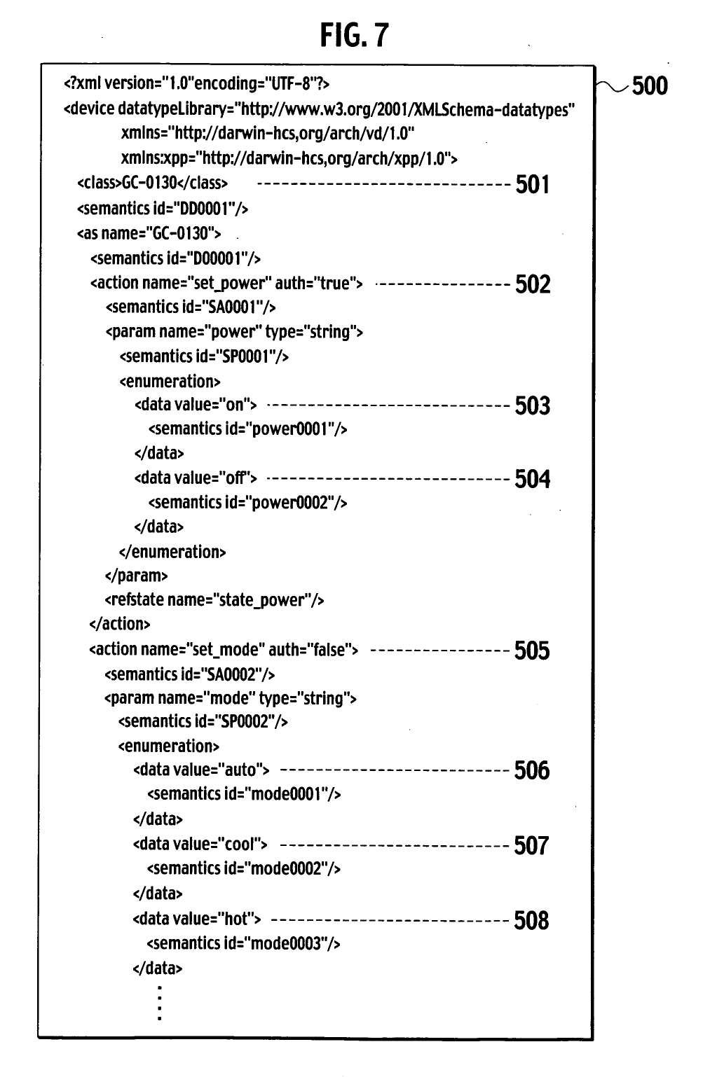

It should be noted that the operation data table T1 of FIG. 6 shows relationships among the device type C1, the operation item C2, the operation content C3 and the authentication necessity C4 for explanation purposes. In the home server 20 and the like, a device class definition (DCD) as shown in FIG. 7 is used as the operation data.

As shown in FIG. 7, the DCD 500 is described according to XML. In the DCD 500, line 501 indicates the device type C1, specifically a DCD for the air conditioner.

Line 502 indicates that authentication is necessary (auth=“true”) when the power is remotely controlled. Lines 503 and 504 indicate the operation content C3 (on and off).

Further, line 505 indicates that authentication is unnecessary (auth=“false”) when the “operation mode” is remotely controlled. Lines 506 to 508 indicate the operation content C3 (automatic, cooling and heating).

(3) Remote Controlled Devices

As shown in FIG. 2, the air conditioner 30 constituting the remote controlled device according to this embodiment includes a transmission-reception unit 301, a controller 305, an authentication necessity decider 307, an authorization verifier 309 and a storage unit 311.

The transmission-reception unit 301 is connected to the home network 2. The transmission-reception unit 301 transmits/receives various data. Specifically, the transmission-reception unit 301 receives the operation direction D2 transmitted by the home server 20.

The controller 305 controls each of the logical blocks constituting the air conditioner 30. The authentication necessity decider 307 determines the necessity of authentication of the operation direction D2 based on the operation direction D2 received by the transmission-reception unit 301 and the operation data (DCD) stored in the storage unit 311.

When the authentication necessity decider 307 determines that the authentication of the operation direction D2 is necessary, the authorization verifier 309 verifies that the operation direction D2 is transmitted by a home server, which has been authorized.

Specifically, the authorization verifier 309 verifies the electronic signature included in the operation direction D2, and thereby authenticates the operation direction D2 received by the transmission-reception unit 301 as transmitted by the authorized home server.

The storage unit 311 stores the operation data for the air conditioner 30. Incidentally, the entrance door 50 shown in FIG. 1 has the same logical block configuration as the air conditioner 30.

The lighting unit 40 includes a transmission-reception unit 401, a controller 405 and a storage unit 407, as shown in FIG. 2. The transmission-reception unit 401, the controller 405 and the storage unit 407 have functions similar to the transmission-reception unit 301, the controller 305 and the storage unit 311, respectively.

Further, the lighting unit 40 includes no authentication necessity decider nor authorization verifier. In other words, authentication of the switching “on” and “off” of the power to the lighting unit 40 is unnecessary as described above. Therefore, the lighting unit 40 need not be provided with an authentication necessity decider or an authorization verifier.

(Authentication Method of Remote Operation Using Authentication System)

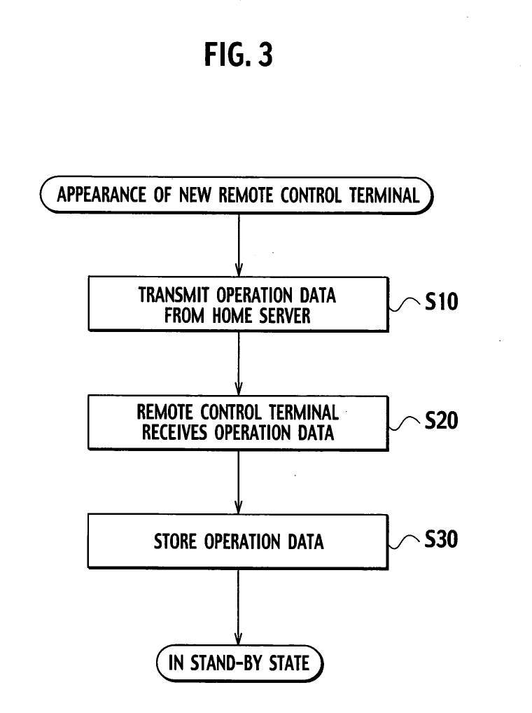

Next, an example of an authentication method for remote operation using the aforementioned authentication system will be described. FIG. 3 shows an operation flow for a case where a remote control terminal (for example, the remote control terminal 10) capable of accessing the home network 2 appears.

As shown in FIG. 3, once the home server 20 recognizes that the remote control terminal 10 has appeared, in step S10, the home server 20 transmits operation data (specifically, the contents of the operation data table T1 as shown in FIG. 6) to the remote control terminal 10.

Incidentally, the home server 20 recognizes that the remote control terminal 10 capable of accessing the home network 2 has appeared based on the notice from the remote control terminal 10.

In step S20, the remote control terminal 10 receives the operation data transmitted by the home server 20.

In step S30, the remote control terminal 10 stores the received operation data in the storage unit 111.

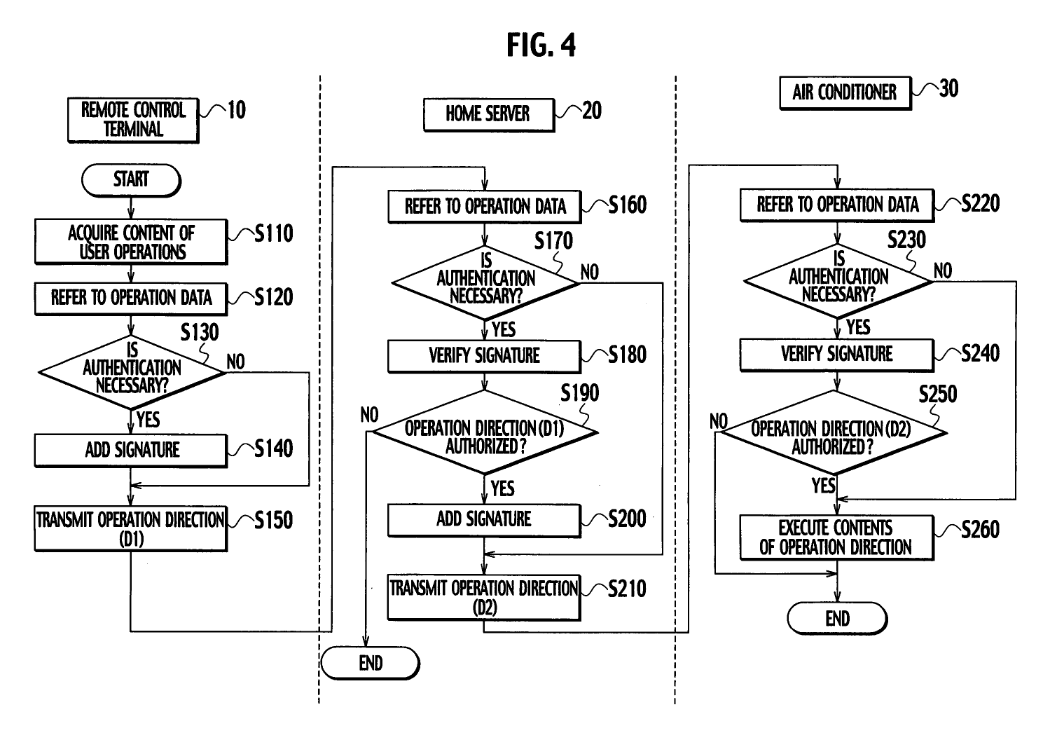

Next, with reference to FIG. 4, an operation flow concerning authentication of operation directions (operation directions D1 and D2) will be described.

In step S110, the remote control terminal 10 acquires content of user operations for remote operation. Specifically, when the user operates the keypad unit 103 installed in the remote control terminal 10, the remote control terminal 10 acquires the operation content. Here, it is supposed that the operation content of the air conditioner 30 is detected.

In step S120, the remote control terminal 10 refers to the operation data stored in the storage unit 111 in step S30.

In step S130, the remote control terminal 10 determines the necessity of authentication of the operation content acquired in step S110.

When the authentication of the operation content is necessary (YES in step S130), the remote control terminal 10 generates the operation direction D1 based on the operation content, and adds an electronic signature to the operation direction D1 in step S140.

On the other hand, when the authentication of the operation content is unnecessary (NO in step S130), the remote control terminal 10 generates the operation direction D1 without adding an electronic signature. Thereafter, the remote control terminal 10 performs a process of step S150.

In step S150, the remote control terminal 10 transmits the operation direction D1 to the home server 20.

In step S160, the home server 20 refers to the operation data stored in the storage unit 213 based on the reception of the operation direction D1 transmitted from the remote control terminal 10.

In step S170, the home server 20 determines the necessity of authentication of the operation direction D1.

When the authentication of the operation direction D1 is necessary (YES in step S170), the home server 20 verifies the electric signature included in the operation direction D1 in step S180. On the other hand, when the authentication of the operation direction D1 is unnecessary (NO in step S170), the home server 20 generates the operation direction D2 for directing remote operation of the air conditioner 30, and thereafter performs a process of step S210.

In step S190, the home server 20 determines whether or not the received operation direction D1 has been authorized based on a result of verification of the electronic signature.

When the operation direction D1 has been authorized (YES in step S190), the home server 20 generates the operation direction D2 for directing remote operation of the air conditioner 30 based on the received operation direction D1, and adds an electronic signature to the operation direction D2 in step S200.

On the other hand, when the operation direction D1 has not been authorized (NO in step S190), the home server 20 ends the process.

In step S210, the home server 20 transmits the operation direction D2 to the air conditioner 30.

In step S220, the air conditioner 30 refers to the operation data stored in the storage unit 311 when the air conditioner 30 received the operation direction D2 transmitted from the home server 20.

In step S230, the air conditioner 30 determines the necessity of authentication of the operation direction D2.

When the authentication of the operation direction D2 is necessary (YES in step S230), the air conditioner 30 verifies the electronic signature included in the operation direction D2 in step S240. On the other hand, when the authentication of the operation direction D2 is unnecessary (NO in step S230), the air conditioner 30 performs a process of step S260.

In step S250, the air conditioner 30 determines whether or not the received operation direction D2 has been authorized based on a result of verification of the electronic signature.

When the received operation direction D2 has been authorized (YES in step S250), the air conditioner 30 executes the operation content(for example, change of setting temperature) based on the received operation direction D2 in step 260.

When the received operation direction D2 has not been authorized (NO in step S250), the air conditioner 30 ends the process without executing the operation content in the operation direction D2.

(Functions and Effects)

According to the above-described authentication system of this embodiment, not all the operation directions, but only operation directions whose authentication is defined as necessary by the operation data are authenticated. This can reduce the time required for authenticating the operation directions.

Further, according to the authentication system according to this embodiment, in the operation data, each operation item indicating the type of operation content corresponds with the necessity of authentication. It is therefore not required to set the necessity of authentication for each operation content, and thus allows easier setting of the necessity of the authentication for the operation directions.

Moreover, according to the authentication system of this embodiment, since the authentication system can achieve easier setting of the necessity of authentication for the operation directions, the workload, when addition and change of the remote controlled devices is required, can be reduced.

### Other Embodiments

Although the contents of the present invention have been described above through a certain embodiment, it is to be understood that the explanations and the drawings constituting part of this disclosure will not limit the scope of the present invention. It is obvious to those skilled in the art that various modifications and alterations are possible from the teachings of this disclosure.

For example, in the aforementioned embodiment of the present invention, although the authorizations of the operation directions D1 and D2 are verified using the respective electronic signatures, the electronic signatures do not have to be used for verifying the authorizations of the operation directions D1 and D2.

Further, in the aforementioned embodiment of the present invention, although the remote control terminal 10 acquired the operation data (specifically, the contents of the operation data table T1) from the home server 20, the remote control terminal 10 may acquire operation data for a remote controlled device (for example, the air conditioner 30) directly from the remote controlled device.

Moreover, in the aforementioned embodiment of the present invention, although the home server 20 and the air conditioner 30 verify the authorizations of the operation directions (D1, D2), it is not necessary that both home server 20 and air conditioner 30 have to verify the authorizations of the operation directions. For example, only the home server 20 may verify the authorization of the operation direction D1 transmitted from the remote control terminal 10.

As described above, it is needless to say that the present invention encompasses various embodiments which are not disclosed herein. Therefore, the technical scope of the present invention shall be solely determined by the matters to define the invention pursuant to the appended claims, which are deemed appropriate from the foregoing description.

What is claimed is:

1. An authentication system for authenticating an operation direction directing remote operation of a remote controlled device connected to a communications network as transmitted by a remote control terminal which has been authorized, comprising:
an operation data storage unit configured to store operation data including an operation item indicating a type of operation content of the remote operation and necessity of an authentication;
an operation direction receiver configured to receive the operation direction from the remote control terminal;
an authentication necessity decider configured to determine the necessity of the authentication based on the operation direction received by the operation direction receiver and the operation data; and
an authenticator configured to authenticate the operation direction as transmitted by the remote control terminal which has been authorized when the authentication necessity decider determines that the authentication is necessary.

2. The authentication system of claim 1, further comprising a signature adder configured to add an electronic signature to the operation direction of the remote operation whose authentication is necessary based on the operation content and the operation data stored in the operation data storage unit, wherein
the authenticator verifies the electronic signature and thereby authenticates the operation direction received by the operation direction receiver as transmitted by the remote control terminal which has been authorized.

3. An authentication method using an authentication system for authenticating an operation direction directing remote operation of a remote controlled device connected to a communications network as transmitted by a remote control terminal which has been authorized, the authentication system including an operation data storage unit for storing operation data including an operation item indicating a type of operation content of the remote operation and necessity of an authentication, the authentication method comprising the steps of:
receiving the operation direction from the remote control terminal; and
authenticating the operation direction as transmitted by the remote control terminal which has been authorized when it is determined that the authentication is necessary based on the operation direction received and the operation data.
